(19) United States
(12) Patent Application Publication
(10) Pub. No.: US 2016/0065476 A1
(43) Pub. Date: Mar. 3, 2016

(54) ACCESS NETWORK CAPACITY MONITORING AND PLANNING BASED ON FLOW CHARACTERISTICS IN A NETWORK ENVIRONMENT

(71) Applicant: CISCO TECHNOLOGY, INC., San Jose, CA (US)

(72) Inventors: K. Tirumaleswar Reddy, BANGALORE (IN); Anca Zamfir, Cheyres (CH); Daniel G. Wing, San Jose, CA (US); William C. VerSteeg, Buford, GA (US); Prashanth Patil, BANGALORE (IN)

(73) Assignee: CISCO TECHNOLOGY, INC., San Jose, CA (US)

(21) Appl. No.: 14/476,336

(22) Filed: Sep. 3, 2014

(51) Int. Cl. H04L 12/803; H04L 12/26

(52) U.S. Cl. CPC H04L 47/122; H04L 43/0888

(57) ABSTRACT

An example method for access network capacity monitoring and planning based on flow characteristics in a network environment is provided and includes receiving, at a server in a first network, a request from a client at a second network for accommodating flow characteristics for a flow through the first network between the client and a remote destination, accommodating the flow characteristics if the request can be fulfilled with available network resources allocated to the client by the first network, measuring the flow at the first network between the client and the remote destination, exporting flow details including flow measurements and the requested flow characteristics to a flow collector, and denying the request if the flow collector determines that the flow measurements do not match the requested flow characteristics. In some embodiments, the flow measurements include fine-grain flow measurements, wherein the method further comprises receiving a request for the fine-grain flow measurements.

### TECHNICAL FIELD

This disclosure relates in general to the field of communications and, more particularly, to access network capacity monitoring and planning based on flow characteristics in a network environment.

### BACKGROUND

Over recent years, as the Internet and cloud networks have evolved, increasing requirements for bandwidth intensive applications such as peer-to-peer file sharing, tele-working, Video-on-Demand and high-definition television have resulted in relentlessly increasing demands for higher broadband bandwidth provisioning. Each of myriad competing technologies providing bandwidth for broadband services has various limitations in terms of bandwidth, reliability, cost or coverage. Network operators currently bear most of the costs and risks of maintaining and upgrading the network for the heavy network usage, but have little ability to monetize the usage. The lack of demand visibility together with lack of a feedback loop between the network and applications forces operators to over-provision the network to minimize service degradation, or to use best-effort service delivery, potentially impacting their ability to offer and get value-added revenue from customized services based on application type, subscriber profile, customer end point device and location, and other characteristics.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a communication system for access network capacity monitoring and planning based on flow characteristics in a network environment;

FIG. 2 is a simplified block diagram illustrating other example details of embodiments of the communication system;

FIG. 3 is a simplified sequence diagram illustrating example operations that may be associated with embodiments of the communication system;

FIG. 4 is a simplified sequence diagram illustrating other example operations that may be associated with embodiments of the communication system;

FIG. 5 is a simplified flow diagram illustrating yet other example operations that may be associated with embodiments of the communication system;

FIG. 6 is a simplified flow diagram illustrating yet other example operations that may be associated with embodiments of the communication system; and

FIG. 7 is a simplified flow diagram illustrating yet other example operations that may be associated with an embodiment of the communication system.

### DETAILED DESCRIPTION OF EXAMPLE EMBODIMENTS

### Overview

An example method for access network capacity monitoring and planning based on flow characteristics in a network environment is provided and includes receiving, at a server in a first network, a request from a client at a second network for accommodating flow characteristics for a flow through the first network between the client and a remote destination, accommodating the flow characteristics if the request can be fulfilled with available network resources allocated to the client by the first network, measuring the flow at the first network between the client and the remote destination, exporting flow details including flow measurements and the requested flow characteristics to a flow collector, and denying the request if the flow collector determines that the flow measurements do not match the requested flow characteristics. In some embodiments, the flow measurements include fine-grain flow measurements, wherein the method further comprises receiving a request for the fine-grain flow measurements.

As used herein, the term “flow characteristics” includes network requirements needed or preferred by the flow, comprising bandwidth (e.g., upstream and downstream), jitter tolerance, delay tolerance, and loss tolerance. Note that “bandwidth” is understood to mean an amount of traffic over a network per unit time; “jitter” refers to undesired deviation from true periodicity of an assumed periodic signal, and may be observed in characteristics such as frequency of successive pulses, signal amplitude, or phase of periodic signals; “delay” specifies how long it takes for a bit of data to travel across the network from one node or endpoint to another; “loss” occurs when one or more packets of data travelling across a computer network fail to reach their destination

### Example Embodiments

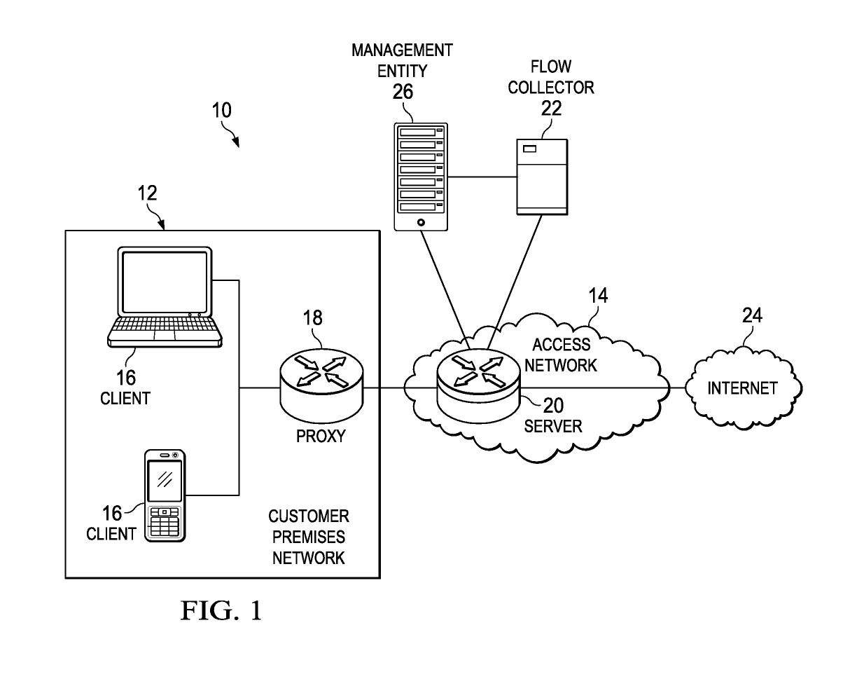

Turning to FIG. 1, FIG. 1 is a simplified block diagram illustrating a communication system 10 for access network capacity monitoring and planning based on flow characteristics in a network environment in accordance with one example embodiment. FIG. 1 illustrates a communication system 10 comprising a customer premises network 12 that subscribes to an access network 14. Customer premises network (CPN) 12 may include one or more client(s) 16 and a proxy 18. Client 16 may communicate through proxy 18 with a server 20 at access network 14. Server 20 may be configured to measure flows from client 16 through access network 14 and export flow details (including flow measurements and requested flow characteristics) to a flow collector 22. Client 16 may receive content from a content provider (and/or may access remote servers, applications and computing resources or communicate with various devices, etc.) or upload content to a content receiver in Internet 24 through access network 14.

As used herein, the term “flow” comprises a set of Internet Protocol (IP) packets passing an observation point in the network during a certain time interval. All packets belonging to a particular flow have a set of common properties. Each property results from applying a function to values of: one or more packet header fields (e.g., source IP address, destination IP address), transport header fields (e.g., source port number, destination port number), or application header fields; one or more characteristics of the packet itself; or one or more fields derived from packet treatment (e.g., next hop IP address, the output interface, etc.). A packet belongs to a particular flow if it completely satisfies all the defined properties of the particular flow.

Flow collector 22 may be located in access network 14, or in a separate network, different from customer premises network 12 and/or access network 14 and may communicate with server 20 to obtain details of client 16's flows through access network 14. A topology aware management entity 26 (e.g., software defined network (SDN) controller or other such application with network management capabilities) may communicate with flow collector 22 and make decisions regarding network capacity planning of access network 14.

In various embodiments, monitoring of client 16's flows can facilitate detecting unexpected client behavior, for example, when client 16 overuses or underuses network resources in access network 14. “Bad” flows, such as flows that overuse network resources without authorization may be flagged, not accommodated, or denied (among other actions) and the network resources may be distributed among the remaining “good” flows for network capacity planning, new plans to meet subscriber needs, etc.

For purposes of illustrating the techniques of communication system 10, it is important to understand the communications that may be traversing the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

Application Enabled Collaborative Networking (AECON) is a framework wherein applications explicitly signal their flow characteristics to the access network, providing network nodes with visibility into the application flow characteristics. Identification and treatment of application flows can be important to many application providers and network operators, who may rely on these capabilities to deploy and/or support a wide range of applications. The applications generate flows that may have specific flow characteristics, including bandwidth, latency, etc. that can be met if made known to the network. AECON advocates a protocol and application independent information model and individual data models that enable explicit communication between applications and networks. AECON permits applications to explicitly signal their flow characteristics to the network and to receive responses from the network that indicate whether or not the network can accommodate the flow characteristics.

Applications can have disparate network requirements, which translate to different flow characteristics, based on the inherent nature of their traffic. For example, web and electronic mail may use high-throughput data with variable rate, bursty long-lived elastic flows, with low tolerance to loss, medium to high tolerance to delay and high tolerance to jitter; real-time traffic such as voice may use telephony services with fixed size small packets, constant emission rate, inelastic and low rate flows with low tolerances to delay, loss and jitter; multimedia conferencing may use variable size packets, constant transmit interval, rate adaptive, loss reactive transmission with low to medium tolerance to loss, medium tolerance to delay and high tolerance to jitter; etc.

Various gaming applications may have different flow characteristics. For example, omnipresent games (e.g., Real-Time Strategies™) have a threshold of acceptable latency (e.g., specifying performance is above 75% of the unimpaired performance) of 1000 ms. Role playing games and massively multiplayer online role-playing games such as Third Person Avatar™ have a threshold of acceptable latency of 500 ms. Games with a first person avatar (e.g., Call of Duty™, Halo™) have a threshold of acceptable latency of 100 ms. The network may react to such different flow characteristics with differentiated services, such as priorities for some flows relative to others (e.g., priority queuing), rate queuing, active queue management, traffic conditioning, assured forwarding, etc.

AECON allows endpoints (e.g., customer equipment) to use protocols (e.g., port control protocol (PCP) and STUN) to signal their expected flow characteristics needs to the access network. In particular, PCP provides a FLOWDATA option that allows a particular endpoint (PCP client) to signal its bi-directional flow characteristics to a corresponding PCP server in the access network. After signaling, the PCP server determines if it can accommodate the flow characteristics, making configuration changes (e.g., to network resources) as necessary to accommodate the flow characteristics, and returns information in the FLOWDATA option indicating its ability to accommodate the described flow characteristics.

Communication system 10 is configured to enhance capabilities of AECON to offer a system and method for access network capacity monitoring and planning based on flow characteristics in a network environment. According to various embodiments, server 20 at access network 14 receives a request from client 16 at client premises network 12 for accommodating flow characteristics for a flow through access network 14 between client 16 and a remote destination (e.g., in Internet 24). In a specific embodiment, the flow characteristics are communicated through a FLOWDATA option of a PCP message from client 16 to server 20 through proxy 18.

Server 20 may accommodate the flow characteristics if the request can be fulfilled with available network resources allocated to client 16 (and/or client premises network 12) by access network 14. Server 20 may measure the flow at access network 14 between client 16 and the remote destination, and export the flow measurements to flow collector 22. In various embodiments, server 20 may be co-located with a Policy Charging and Enforcement Function (PCEF) that sends Internet Protocol Flow Information Export (IPFIX) records to flow collector 22. The IPFIX records may include flow measurements such as subscriber details, flow characteristics requested by client 16 and flow characteristics offered by access network 14.

Server 20 may deny the request if flow collector 22 determines that the flow measurements do not match the requested flow characteristics. In some embodiments, flow collector 22 may suspect deviations of the flow measurements from the requested flow characteristics. Denying the request can include re-prioritizing the flow (e.g., lowering its priority), dropping packets of the flow, or otherwise denying the flow characteristics requested by client 16. Flow collector 22 may request fine-grain flow measurements in such scenarios. Fine-grain measurements have higher sampling rate than coarser-grained measurements. For example, in fine-grain flow measurements, flow details may be exported to flow collector 22 more frequently than with coarser-grained flow measurements (e.g., flow measurement with a fine-grain sampling rate of two may collect data from every other packet of the flow; in contrast, with a coarse-grain sampling rate of 30, flow measurement may collect data from every 30^{th} packet).

In some embodiments, flow collector 22 may inform management entity 26 of the need for fine-grain flow measurement. Management entity 26 may send a request to server 20 for fine-grain flow measurements. In some embodiments, flow collector 22 may analyze the flow measurements, and determine that the flow measurements do not match the requested flow characteristics. Flow collector 22 may inform management entity 26, which can take further network capacity planning decisions. For example, in cases where the mismatch between the flow measurements and the requested flow characteristics indicates that flow does not consume all the requested flow characteristics, any extra network resources allocated to accommodate the requested flow characteristics may be freed up for other flows. In cases where the mismatch between the flow measurements and the requested flow characteristics indicates that the flow consumes more than the requested flow characteristics, the flow may be penalized for “bad” behavior. In such cases, management entity 26 may instruct server 20 to deny the request from client 16 for the flow characteristics.

In some embodiments, server 20 may measure a plurality of flows of client premises network 12 that traverse access network 14 and identify anomalous flows of client premises network 12. Server 20 may export flow measurements of the anomalous flows to flow controller 22. Anomalous flows may be identified in various ways. For example, anomalous flows may be indicated when server 20 identifies flows from client premises network 12 that do not consume the requested flow characteristics and deviate from relevant PCP FLOWDATA information. For example, client 16 requests X MBPS for upstream and Y MBPS for downstream traffic for a specific flow but utilizes only x MBPS (x<<X) and/or y MBPS (y<<Y). Server 20 may send the flow details, flow characteristics requested, flow characteristics offered by access network 14, deviation details, etc. to flow collector 22.

In another example, anomalous flows may be indicated when client 16 switches a flow to a lower bit-rate based on lack of accommodation of the requested flow characteristics. If a user abandons a particular application at client 16 or changes the flow to backup (e.g., changing a state of Multi-Path Transmission Control Protocol (MPTCP) sub-flows to backup) then such behavior can indicate that access network 14 is not able to cater to the needs of the application and such details may also be exported to flow collector 22. In yet another example, the anomalous flows can be indicated by repeated re-tries by Client 16 to obtain accommodation of flow characteristics by access network 14.

In yet another example, the anomalous flows may be indicated by termination of other applications in client premises network 12 to execute a specific application at a high bit rate. For example, a PCP “MAP” request with a requested lifetime set to zero indicates a request to delete an existing mapping, and the MAP request can be indicative of the anomalous flow wherein access network 14 is not able to support the application's flow characteristics. In yet another example, the anomalous flows are indicated by flow characteristics that exceed limits set by a third party authorization server. An example of a third party authorization server comprises a content provider that has an agreement with an Internet Service Provider (ISP) operating access network 14. Mobile networks use techniques like allocation and retention priority (ARP) to accommodate high-priority flows by penalizing low-priority flows; and embodiments of communication system 10 may achieve the same result through different mechanisms.

In some scenarios, flow characteristics requested by client 16 may exceed the limit granted by the third party authorization server, and can indicate misuse. Flow details of such misuse can be exported to flow collector 22. In yet another example, if the third party authorization is misused by either client 16 or the content provider, the flow measurements of such flow may be exported to flow collector 22. If the same operator is offering 3G, Wi-Fi, LTE, etc., flow collector 22 can determine if a host (e.g., client 16) with multiple interfaces has selected a specific interface for an application because other interfaces could not meet the requested flow characteristics. For example, a PCP FLOWDATA request on multiple interfaces can be correlated using an instance identifier field in a PCP FLOWDATA option. Various other network behaviors indicative of efforts by client premises network 12 to reduce a bandwidth impact on access network 14 may be indicative of anomalous flows within the broad scope of the embodiments.

According to embodiments of communication system 10, appropriate rules configured in flow collector 22 can facilitate identifying subscribers (e.g., entities or individuals that operate customer premises network 12) that exhibit anomalies in their traffic flow requests and flow collector 22 can request server 20 to dynamically increase the granularity of traffic flow measurement. Flow measurement (and/or collection) instructions can be programmed using management entity 26, for example, implemented in a SDN controller. The instructions may indicate starting with coarse-grained statistics for a particular subscriber and requesting finer-grained information collection after anomalous (e.g., suspicious) deviation is identified. Thus, according to various embodiments, all flows from all subscribers need not be collected, potentially reducing traffic monitoring overhead.

In some embodiments, information collected at access network 14 can be shared with third party authorization servers, potentially identifying at least some reasons impacting consuming experience of every single subscriber. In addition, flow collector 22 may use the additional records together with the records collected using a pre-configured sampling rate. Flow collector 22 can generate accurate information that can be used for capacity planning, generating new allocation plans that meet needs of a group of subscribers, identifying malicious requests for penalizing flows/subscribers etc.

In various embodiments, after sufficient IPFIX records are generated, flow collector 22 can determine with a high level of certainty that either client 16 or the content provider is “lying” and could inform server 20 to take appropriate action (e.g., deny the flow, etc.) Embodiments of communication system 10 can help identify any “fraud” by client 16 or the third party authorization server and only the “good” (e.g., non-anomalous) flows may be used (e.g., to identify various network constraints) for capacity planning. In some embodiments, access network 14 can monitor and enforce client 16's requested bandwidth and react if client 16 exceeds its requested bandwidth, by various actions, such as terminating flow completely, sending a network alert to client 16, etc.

Embodiments of communication system 10 can enable access network 14 to determine if any of its subscribers or any content provider is “lying” (e.g., exhibiting anomalous behavior) and appropriate action may be taken against such flows. After the “bad” (e.g., anomalous) behavior are identified at access network 14, other flows may be regarded as “good” (e.g., non-anomalous), and flow records collected by flow collector 22 for the good flows may be used for various capacity planning activities. Thus, access network 14 can penalize only “bad” (e.g., anomalous) flows, and flow records collected from “good” flows can be used to enhance business through appropriate capacity planning, new plans to meet the needs of subscribers etc.

In some embodiments, access network 14 can comprise an enterprise network, or a mobile network. Various details, such as subscriber interactions, behavior, and tolerance levels can be measured and collected to enhance user experience. In some embodiments, the flow records at flow collector 22 may be validated, and the validated flow records may be subjected to Big Data Analytics (e.g., using MapReduce™ to identify subscribers who use Netflix and in descending order sort the number of times one-way video streaming traffic flow characteristics could not be met.)

Note that although the operations are described herein with reference to PCP, any suitable protocol amenable to communicating flow characteristics with appropriate authentication, authorization, and security can be used for the communication operations described herein within the broad scope of the embodiments. For example, protocols that are lightweight (e.g., without requiring too many resources on client 16 and server 18), support authentication and authorization, allow adding meta-data (e.g., flow characteristics), facilitate extensions (e.g., to permit communication of additional data, etc.) and may be implemented as part of a user process or library that does not require any special privileges may be suitable for use in embodiments described herein. Examples of such protocols can include PCP and STUN.

In some embodiments, as AECON protocols are end-to-edge (and not end-to-end), reasons for under-utilization of access network 14 may be determined based on flow-related information such as Explicit Congestion Notification (ECN), ConEx destination option (CDO) (CDO is a destination option that can be included in IPv6 datagrams that are sent by Con Ex-aware senders in order to inform ConEx-aware nodes on the path about the congestion encountered by packets earlier in the same flow), re-transmission of packets, etc. Based on the available network information, server 20 at access network 14 (or flow controller 22, or management entity 26) can detect if client 16 is lying.

When under-utilization is detected, flow collector 22 may wait for a predetermined time interval (e.g., N seconds) for endpoints to either signal reduced flow characteristics (e.g., reduced bandwidth utilization), or recover and increase the bandwidth utilization. After timeout (e.g., end of predetermined time interval), flow collector 22 may reduce priority of the flow and inform client 16 about the updated flow characteristics. In some embodiments, after monitoring a preconfigured (e.g., M) number of flows and identifying that customer premises network 12 has lied multiple time, access network 14 may penalize customer premises network 12 (e.g., by denying the flows therefrom, reducing available resources to service the flows, etc.). In various embodiments, customers/subscribers and providers can benefit from a provable assertion of performance as described herein related to some contract whereby current opportunistic allocations can result in either poor performance (e.g., over-committed resources) or stranded resources (e.g., under-committed resources).

Turning to the infrastructure of communication system 10, the network topology of networks 12 and 14 can include any number of computing devices, smartphones, servers, hardware accelerators, virtual machines, switches (including distributed virtual switches), routers, and other nodes inter-connected to form a large and complex network. A node may be any electronic device, client, server, peer, service, application, or other object capable of sending, receiving, or forwarding information over communications channels in a network. Elements of FIG. 1 may be coupled to one another through one or more interfaces employing any suitable connection (wired or wireless), which provides a viable pathway for electronic communications. Additionally, any one or more of these elements may be combined or removed from the architecture based on particular configuration needs.

Communication system 10 may include a configuration capable of TCP/IP communications for the electronic transmission or reception of data packets in a network. Communication system 10 may also operate in conjunction with a User Datagram Protocol/Internet Protocol (UDP/IP) or any other suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of communication system 10. It should be understood that communication system 10 shown in FIG. 1 is simplified for ease of illustration.

The example network environment may be configured over a physical infrastructure that may include one or more networks and, further, may be configured in any form including, but not limited to, local area networks (LANs), wireless local area networks (WLANs), VLANs, metropolitan area networks (MANs), VPNs, Intranet, Extranet, any other appropriate architecture or system, or any combination thereof that facilitates communications in a network.

In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In various embodiments, client 16, proxy 18, and server 20 can comprise physical machines; in other embodiments, client 16, proxy 18 and server 20 can comprise virtual machines instantiated on physical machines; in yet other embodiments, some of client 16, proxy 18 and server 20 may comprise physical machines, and the others may comprise virtual machines. In some embodiments, client 16 may be instantiated on a media player or other computing device in customer premises network 12; proxy 18 may be instantiated on a router in customer premises network 12; server 18 may be instantiated in any suitable computing device or network element at access network 14. In embodiments wherein PCP is used, client 16, proxy 18 and server 20 may be PCP-aware. Server 20 may execute in a network element such as a firewall or network address translation (NAT) appliance, and may comprise a capability of such appliance. In some embodiments, server 20 may also be provided on another network element that communicates with the actual NAT or firewall, for example, via some proprietary mechanism that is transparent to proxy 18.

In various embodiments, flow collector 22 may comprise any suitable network element configured to accept flow details, such as IPFIX records, and analyze flows. As used herein, the term “network element” is meant to encompass computers, network appliances, servers, routers, switches, gateways, bridges, load-balancers, firewalls, processors, modules, or any other suitable device, component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information.

In other embodiments, flow collector 22 can comprise an application executing in a suitable network element. Note that an “application” as used herein this Specification, can be inclusive of an executable file comprising instructions that can be understood and processed on a computer, and may further include library modules loaded during execution, object files, system files, hardware logic, software logic, or any other executable modules. In other embodiments, flow collector 22 can comprise software modules that interact with other server applications, for example, a PCP-aware server application. In yet other embodiments, flow collector 22 can comprise stand-alone network appliances configured to perform the flow receiving and analyzing functions as described herein.

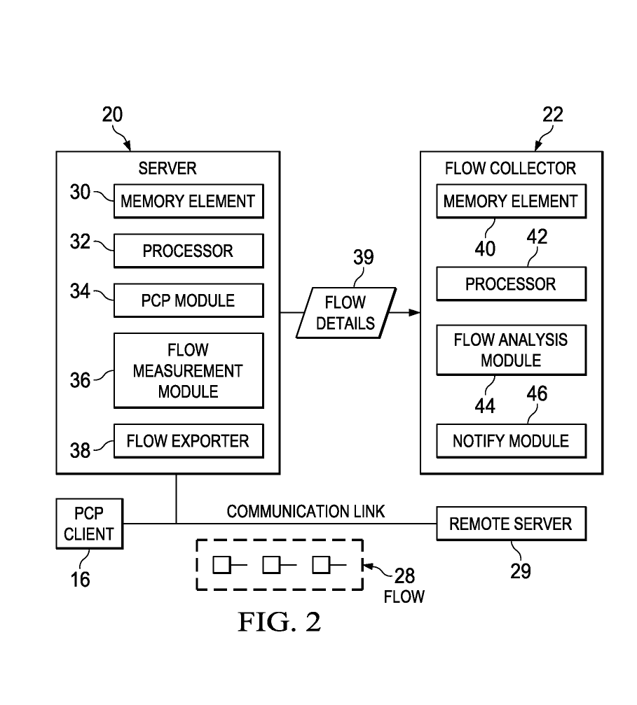

Turning to FIG. 2, FIG. 2 is a simplified block diagram illustrating example details of an embodiment of communication system 10. An example server 20 may intercept and observe a flow 28 (comprising packets of information) between client 16 and a remote server 29. Server 20 may include a memory element 30 and a processor 32, in addition to various software modules, such as a PCP module 34, a flow measurement module 36 and a flow exporter 38. PCP module 34 may be configured to understand PCP (and equivalent protocols) to identify flow characteristics requested by client 16. Flow measurement module 36 may be associated with suitable hardware components to observe and measure flow 28 appropriately. Flow exporter 38 may format the measured flow details and the requested flow characteristics into flow details 39, which can comprise one or more IPFIX records in some embodiments. Flow details 39 may be exported to flow collector 22.

Flow collector 22 may include a memory element 40, a processor 42, and a flow analysis module that can analyze information included in flow details 39. For example, flow analysis module can determine whether the requested flow characteristics match the measured flow details and a notify module 46 may notify central management entity 26 or server 20 of a need for fine-grained measurements if a mismatch exists. In some embodiments, flow details 39 may include fine-grained flow measurements of flow 28. Flow analysis module 44 may compare the fine-grained flow measurements with requested flow characteristics and identify deviations, if any. Notify module 46 may notify central management entity 26 or server 20 of the deviations, which information may be used by central management entity 26 for various network capacity planning activities.

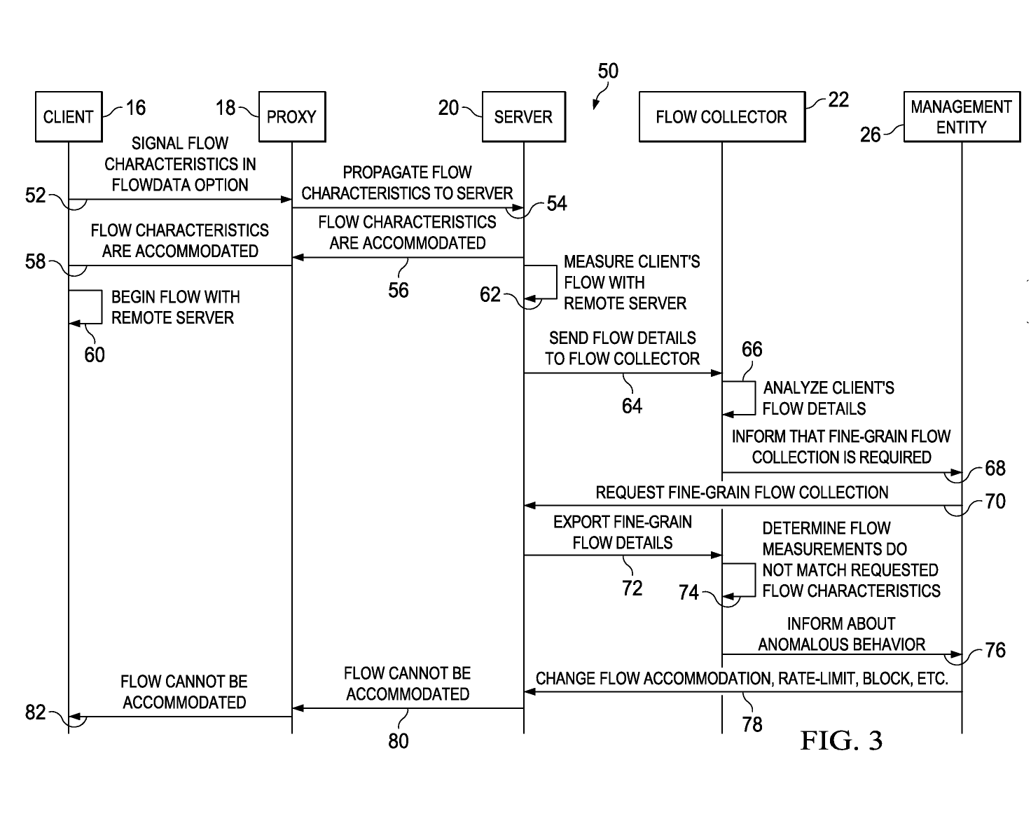

Turning to FIG. 3, FIG. 3 is a simplified sequence diagram illustrating example operations 50 that may be associated with embodiments of communication system 10. At 52, client 16 may signal flow characteristics in a FLOWDATA option to proxy 18. At 54, proxy 18 may propagate the flow characteristics to server 20 in access network 14. At 56, server 20 may respond to proxy 18 accommodating the flow characteristics. At 58, proxy 18 may inform client 16 that the flow characteristics are accommodated. At 60, client 16 may begin flow 28 with remote server 29. At 62, server 20 may measure flow 28. At 64, server 20 may send flow details 39 to flow collector 22. At 66, flow collector 22 may analyze client 16's flow details 39. At 68, flow collector may determine that fine-grain flow collection is required, and may suitably inform management entity 26.

At 70, management entity 26 may request server 20 to take fine-grain flow measurements. At 72, server 20 may measure flow details at fine-grain specifications (e.g., more frequently), and export fine-grain flow details 39 to flow collector 22. At 74, flow collector 22 may determine that flow measurements do not match requested flow characteristics. At 76, flow collector 22 may inform management entity 26 about the anomalous behavior. At 78, management entity 26 may make a decision to deny flow 28, and may instruct server 20 to change flow accommodation, rate-limit, block flow 28, or take other suitable preventative action. At 80, server 20 may inform proxy 18 that flow 28 cannot be accommodated. At 82, proxy 18 may inform client 16 that flow 28 cannot be accommodated.

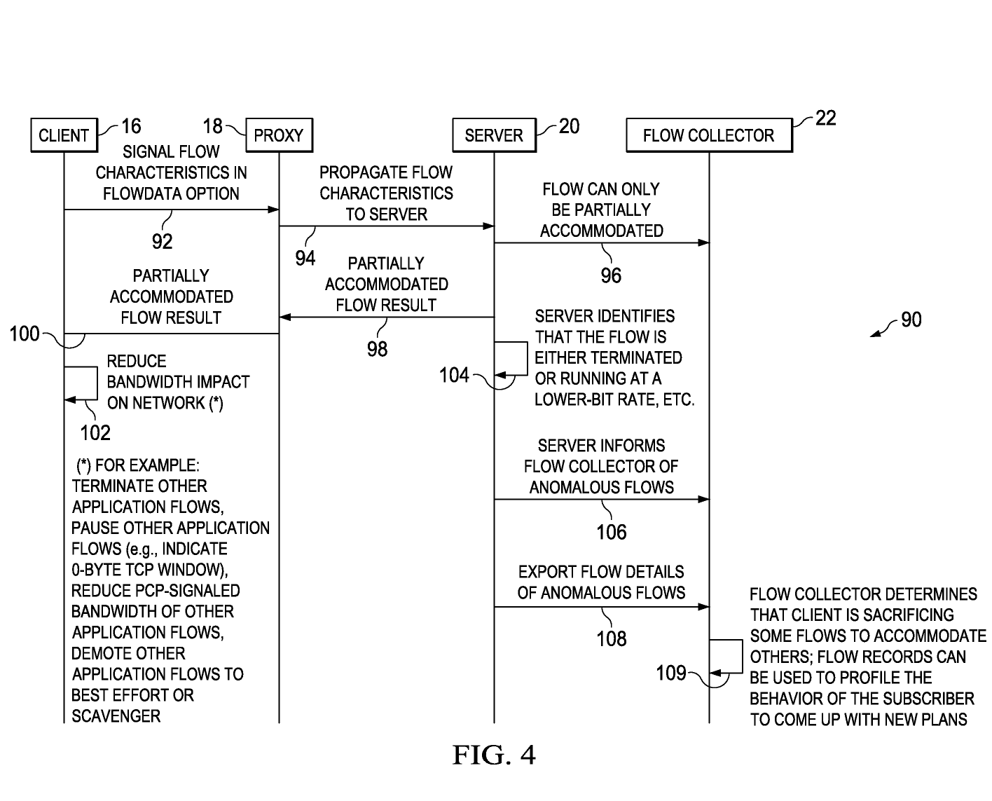

Turning to FIG. 4, FIG. 4 is a simplified sequence diagram illustrating example operations 90 that may be associated with an embodiment of communication system 10. At 92, client 16 may signal flow characteristics in a suitable FLOWDATA option to proxy 18. At 94, proxy 18 may propagate the flow characteristics to server 20 in access network 14. At 96, server 20 may inform flow collector 22 that the requested flow characteristics can be accommodated only partially. At 98, server 20 may inform proxy 18 that the requested flow characteristics can be accommodated partially. At 100, proxy 18 may inform client 16 that the requested flow characteristics can be accommodated partially. Thereupon, client 16 may take appropriate actions to reduce bandwidth impact on access network 14. For example, client 16 may terminate other application flows in favor of a higher priority flow; client 16 may pause other application flows (e.g., by indicating 0-byte TCP window), reduce PCP signaled bandwidth of other application flows (e.g., request less flow characteristics for the other flows), demote other application flows to best efforts or scavenger, etc.

At 104, server 20 may identify that the requested flow is terminated, or running at lower bit-rate, or other flows are terminated or paused in preference to the requested flow, etc. At 106, server 20 may inform flow collector 22 of anomalous flows. At 108, server 20 may export flow details of anomalous flows to flow collector 22. At 109, flow collector 22 may determine that client 16 is sacrificing some flows to accommodate other flows. In some embodiments, flow records can be used to profile the behavior of the subscriber (e.g., client premises network 12) to generate new, more appropriate usage plans.

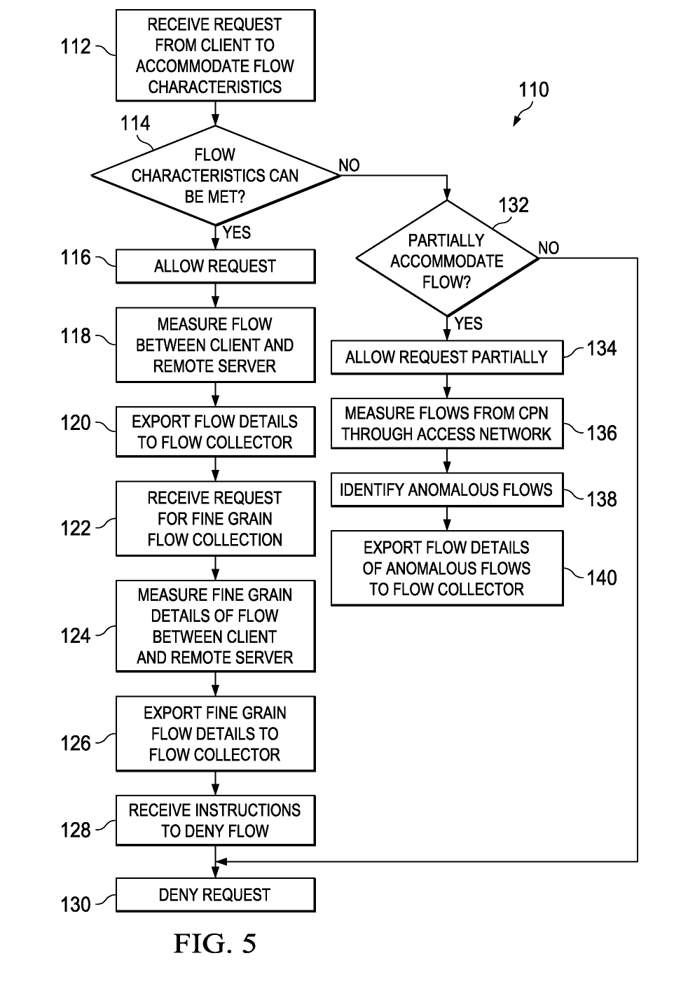

Turning to FIG. 5, FIG. 5 is a simplified flow diagram illustrating example operations that may be associated with embodiments of communication system 10. At 112, server 20 may receive request from client 16 (e.g., propagated by proxy 18) to accommodate certain flow characteristics. At 114, server 20 may make a determination whether the requested flow characteristics can be met. If the requested flow characteristics can be met, at 116, server 20 may allow the request. At 118, server 20 may measure flow 28 between client 16 and remote server 29. At 120, server 20 may export flow details 39 to flow collector 22. At 122, server 20 may receive a request for fine-grain flow collection. In some embodiments, the request may be received from management entity 26; in other embodiments, the request may be received from flow collector 22. At 124, server 20 may take fine-grain flow measurements of flow 28 between client 16 and remote server 29. At 126, the fine-grain flow details 39 may be exported to flow collector 22. At 128, server 20 may receive instructions (e.g., from management entity 26, or flow collector 22) to deny flow 28 (or take other suitable preventative actions to prevent flow 28 from consuming more than the requested flow characteristics). At 130, server 20 may deny flow 28 accordingly.

Turning back to 114, if the flow characteristics cannot be accommodated, at 132, a determination may be made if the flow characteristics can be accommodated partially. If not, the operations may step to 130, and the request may be denied. On the other hand, if the flow characteristics can be met partially, at 134, the request for flow characteristics may be partially allowed. At 136, server 20 may measure flows from client premises network 12 through access network 14. At 138, server 20 may identify anomalous flows. At 140, server 20 may export flow details of anomalous flows to flow collector 22 for further network capacity planning activities, as appropriate.

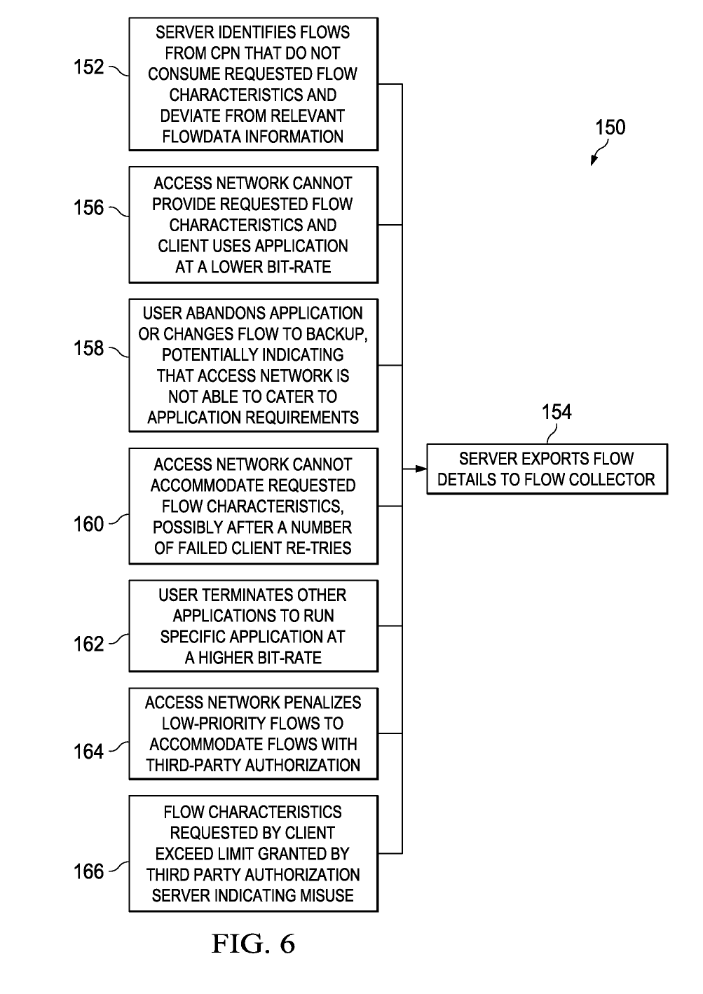

Turning to FIG. 6, FIG. 6 is a simplified flow diagram illustrating example operations 150 that may be associated with embodiments of communication system 10. At 152, server 20 may identify flows from CPN 12 that do not consume requested flow characteristics and deviate from relevant FLOWDATA information (e.g., provided in a PCP message from client 16 to server 20 through proxy 18). At 154, server 20 may export flow details 39 to flow collector 22. At 156, a scenario may arise that access network 14 cannot provide the requested flow characteristics and client 16 may use the relevant application at a lower bit-rate. Server 20 may detect such anomaly (e.g., deviation from requested flow characteristics), and the operations may step to 154, at which server 20 exports relevant flow details 39 to flow collector 22. A 158, a user (e.g., human operator) may abandon the relevant application or change flow to backup, potentially indicating that access network 14 is not able to cater to the application flow requirements. Server 20 may detect such anomaly, and the operations may step to 154, at which server 20 exports relevant flow details 39 to flow collector 22.

At 160, server 20 may detect that access network 14 cannot accommodate the requested flow characteristics, possibly after a number of failed client re-tries. The operations may step to 154, at which server 20 exports relevant flow details 39 to flow collector 22. At 162, the user may terminate other applications to run the specific application at a higher bit-rate. Server 20 may detect such anomaly, and the operations may step to 154, at which server 20 exports relevant flow details 39 to flow collector 22. At 164, server 20 may detect that access network 14 penalizes low-priority flows to accommodate flows with third-party authorization. The operations may step to 154, at which server 20 exports relevant flow details 39 to flow collector 22. At 166, a determination may be made that the flow characteristics requested by client 16 exceed the limit granted by third party authorization server, indicating possible misuse. The operations may step to 154, at which server 20 exports relevant flow details 39 to flow collector 22. Various other client and access network activities may also indicate anomalous flow behavior, where deviation of the actual flow from the requested flow characteristics may be observed and measured. Note that the deviation may be determined (e.g., based on comparison between flow measurements and requested flow characteristics) by any suitable network element, including flow collector 22, server 20, or management entity 26, within the broad scope of the embodiments.

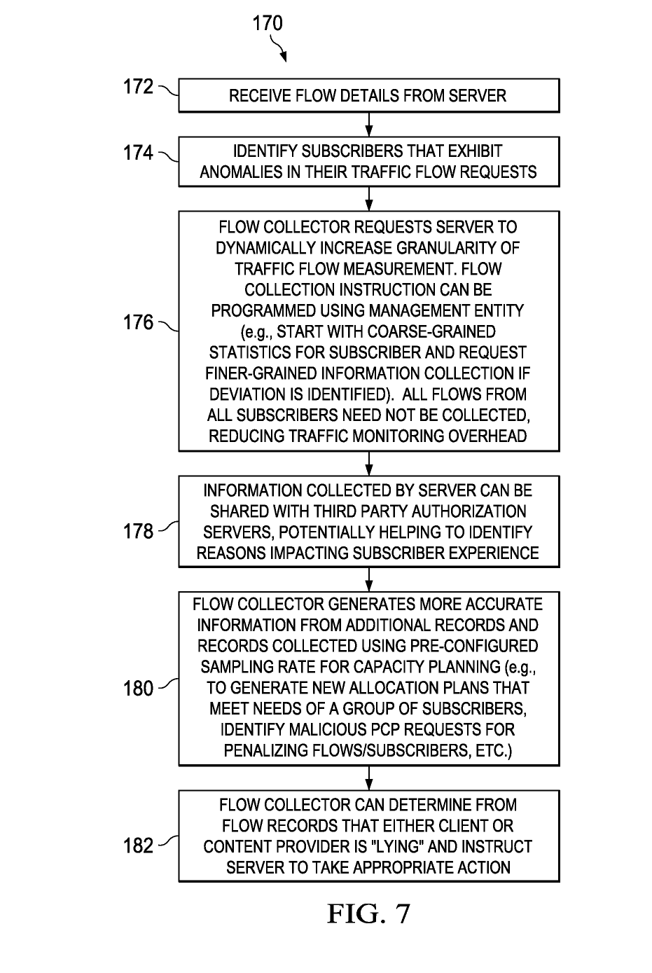

Turning to FIG. 7, FIG. 7 is a simplified flow diagram illustrating example operations 170 that may be associated with embodiments of communication system 10. At 172, flow collector 22 may receive flow details 39 from server 20. At 174, flow collector 22 (or management entity 26 in some embodiments) may identify subscribers (e.g., CPN 12) that exhibit anomalies (e.g., deviations in actual behavior) in their traffic flow requests (e.g., for certain flow characteristics). At 176, flow collector 22 (or management entity 26 in some embodiments) may request server 20 to dynamically increase granularity of traffic flow measurements (e.g., by increasing sampling rate). Flow collection instruction can be programmed using management entity 26 (e.g., start with coarse-grained statistics for subscriber and request finer-grained information collection if deviation is identified). All flows from all subscribers need not be collected, reducing traffic monitoring overhead. At 178, the information collected by server 20 can be shared with third-party authorization servers, potentially helping to identify reasons impacting subscriber experience.

At 180, flow collector 22 may generate more accurate information from additional records and records collected using pre-configured sampling rate for capacity planning (e.g., to generate new allocation plans that meet needs of a group of subscribers, identify malicious PCP requests for penalizing flows/subscribers, etc.). At 182, flow collector 22 can determine from flow records that either client 16 or content provider (e.g., in Internet 24) is “lying” and instruct (e.g., through management entity 26 in some embodiments) server 20 to take appropriate action.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. Note also that an ‘application’ as used herein this Specification, can be inclusive of an executable file comprising instructions that can be understood and processed on a computer, and may further include library modules loaded during execution, object files, system files, hardware logic, software logic, or any other executable modules. Furthermore, the words “optimize,” “optimization,” and related terms are terms of art that refer to improvements in speed and/or efficiency of a specified outcome and do not purport to indicate that a process for achieving the specified outcome has achieved, or is capable of achieving, an “optimal” or perfectly speedy/perfectly efficient state.

In example implementations, at least some portions of the activities outlined herein may be implemented in software in, for example, server 20 and flow collector 22. In some embodiments, one or more of these features may be implemented in hardware, provided external to these elements, or consolidated in any appropriate manner to achieve the intended functionality. The various network elements (e.g., server 20 and flow collector 22) may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, server 20 and flow collector 22 described and shown herein (and/or their associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory elements 30, 40) can store data used for the operations described herein. This includes the memory element being able to store instructions (e.g., software, logic, code, etc.) in non-transitory media, such that the instructions are executed to carry out the activities described in this Specification. A processor can execute any type of instructions associated with the data to achieve the operations detailed herein in this Specification. In one example, processors (e.g., processors 32, 42) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

These devices may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in communication system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing and sequence of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, communication system 10 may be applicable to other exchanges or routing protocols. Moreover, although communication system 10 has been illustrated with reference to particular elements and operations that facilitate the communication process, these elements, and operations may be replaced by any suitable architecture or process that achieves the intended functionality of communication system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method executed by a server in a first network, comprising:
receiving a request from a client at a second network for accommodating flow characteristics for a flow through the first network between the client and a remote destination;
accommodating the flow characteristics if the request can be fulfilled with available network resources allocated to the client by the first network;
measuring the flow at the first network between the client and the remote destination;
exporting flow details including flow measurements and the requested flow characteristics to a flow collector; and
denying the request if the flow collector determines that the flow measurements do not match the requested flow characteristics.

2. The method of claim 1, wherein the flow characteristics are communicated through a FLOWDATA option of a port control protocol (PCP) message from the client to the server.

3. The method of claim 1, wherein the flow measurements comprise fine-grain flow measurements, wherein the method further comprises receiving a request for the fine-grain flow measurements.

4. The method of claim 3, wherein the flow collector informs a management entity of a need for fine-grain flow measurements, wherein the management entity sends the request for the fine-grain flow measurements.

5. The method of claim 4, wherein instructions to deny the request is received from the management entity.

6. The method of claim 1, further comprising:
measuring a plurality of flows of the second network that traverse the first network;
identifying anomalous flows in the second network; and
exporting flow measurements of the anomalous flows to the flow controller.

7. The method of claim 6, wherein the anomalous flows are indicated by at least one flow being switched to lower bit-rate based on lack of accommodation of the requested flow characteristics.

8. The method of claim 6, wherein the anomalous flows are indicated by repeated re-tries by the client to obtain accommodation of flow characteristics by the first network.

9. The method of claim 6, wherein the anomalous flows are indicated by termination of other applications in the second network to execute a specific application at a high bit rate.

10. The method of claim 6, wherein the anomalous flows are indicated by flow characteristics that exceed limits set by a third party authorization server.

11. Non-transitory tangible media that includes instructions for execution, which when executed by a processor of a server in a first network, is operable to perform operations comprising:
receiving a request from a client at a second network for accommodating flow characteristics for a flow through the first network between the client and a remote destination;
accommodating the flow characteristics if the request can be fulfilled with available network resources allocated to the client by the first network;
measuring the flow at the first network between the client and the remote destination;
exporting flow details including flow measurements and the requested flow characteristics to a flow collector; and
denying the request if the flow collector determines that the flow measurements do not match the requested flow characteristics.

12. The media of claim 11, wherein the flow measurements comprise fine-grain flow measurements, wherein the method further comprises receiving a request for the fine-grain flow measurements.

13. The media of claim 12, wherein the flow collector informs a management entity of a need for fine-grain flow measurements, wherein the management entity sends the request for the fine-grain flow measurements.

14. The media of claim 13, wherein instructions to deny the request is received from the management entity.

15. The media of claim 11, wherein the operations further comprise:
measuring a plurality of flows of the second network that traverse the first network;
identifying anomalous flows in the second network; and
exporting flow measurements of the anomalous flows to the flow controller.

16. An apparatus in a first network, comprising:
a memory element for storing data; and
a processor, wherein the processor executes instructions associated with the data, wherein the processor and the memory element cooperate, such that the apparatus is configured for:
receiving a request from a client at a second network for accommodating flow characteristics for a flow through the first network between the client and a remote destination;
accommodating the flow characteristics if the request can be fulfilled with available network resources allocated to the client by the first network;
measuring the flow at the first network between the client and the remote destination;
exporting flow details including flow measurements and the requested flow characteristics to a flow collector; and
denying the request if the flow collector determines that the flow measurements do not match the requested flow characteristics.

17. The apparatus of claim 16, wherein the flow measurements comprise fine-grain flow measurements, wherein the method further comprises receiving a request for the fine-grain flow measurements.

18. The apparatus of claim 17, wherein the flow collector informs a management entity of a need for fine-grain flow measurements, wherein the management entity sends the request for the fine-grain flow measurements.

19. The apparatus of claim 18, wherein instructions to deny the request is received from the management entity.

20. The apparatus of claim 16, further configured for:
measuring a plurality of flows of the second network that traverse the first network;
identifying anomalous flows in the second network; and
exporting flow measurements of the anomalous flows to the flow controller.
